(19) United States
(12) Patent Application Publication
(10) Pub. No.: US 2018/0053162 A1
(43) Pub. Date: Feb. 22, 2018

(54) ON-LINE PAYMENT SYSTEM

(71) Applicant: Peter Allen Janes, Buckinghamshire (GB)

(72) Inventor: Peter Allen Janes, Buckinghamshire (GB)

(21) Appl. No.: 15/681,176

(22) Filed: Aug. 18, 2017

Related U.S. Application Data
(60) Provisional application No. 62/377,272, filed on Aug. 19, 2016.

(51) Int. Cl. G06Q 20/10; G06Q 30/06

(52) U.S. Cl. CPC G06Q 20/102; G06Q 30/0603; G06Q 30/0641

(57) ABSTRACT

A payment holding computer system is provided to take payment from a buyer using a computer on a network and hold that for a time, paying it out to a seller on the network when the buyer indicates. The payment holding computer system also verifies the identity of the parties to the sale. The seller may instruct the payment holding computer to return the payment.

### RELATED APPLICATIONS

This application claims priority to and benefit of U.S. Provisional Patent Application 62/377,272, filed Aug. 19, 2017, and entitled “ON-LINE PAYMENT SYSTEM” (attorney docket number P025640US/107687.00044), which is hereby incorporated by reference for all purposes as if set forth herein in its entirety.

### TECHNICAL FIELD

The present invention relates to a system for making payments on-line.

### BACKGROUND

Much commercial activity makes use of computer systems connected by the Internet, or other networks. These systems allow buyers and sellers to interact at a distance. Common examples or this are computer systems that enable orders to be placed at a distance and payments to be processed remotely.

Online shop websites sell goods and services and take payments through payment services such as credit and debit cards and specialist online payment services. The computer systems—and the electronic messages sent between them involved in this process—are shown in FIG. 1. The buyer, using their Internet connected computer or mobile device 101, uses the website to select goods by searching, or otherwise navigating through a catalog of available goods or services held in the database 102 of the website, causing the website's web server 103 to transfer to the buyer's computer or mobile device 101 pages, to be displayed thereon, providing information about and images of particular goods or services. The user makes their selection, usually by adding the goods or service to a temporary list held in the website's server 103. Once the buyer has finished compiling that list they indicate to the web server that they wish now to buy the goods or services, usually by navigating to a web page, the “shopping basket” showing their list of selected goods or services and clicking the relevant button, which for example may be marked “check out”.

The website then provides the buyer with an interface, the payment web pages, which collect the buyer's details necessary to obtain payment from the buyer's bank, credit card account, etc. The website contacts the computer system 104 of the relevant payment service, which, once the authenticity of the payment instruction is verified, transfers the payment to the bank account of the website operator, or in some cases directly to the seller, where that is a different person from the website operator. In the latter case an alternative is for the website to receive the payment and to keep it in an account for transfer to the seller later, conveniently in a single payment covering several sales made via the website.

Once the payment is made the website also sends a message to the computer system 106 of the fulfilment system, telling it which goods or services to provide. This message may be as simple as an email to the warehouse. In more automated systems the message is machine readable and the warehouse is automated and responds to the message by automatically picking the goods and transferring them to the delivery agent, for example, the postal service, couriers and so on.

In this system, once they have made their payment, the buyer takes it on trust that the goods or services will be delivered by the seller. This trust is usually quite easy to give as the system is quite a substantial one and so must have required substantial financial investment. Also if the website offers credit card payments the buyer may be protected by law and the knowledge that to keep a merchant account with a credit card provider the merchant must not receive too many complaints.

In traditional shops, which hold stock and allow buyers to visit the shop, the Internet or other private networks are also used to facilitate transactions with shoppers. This is perhaps not quite so plain to the buyer and seller, but happens nonetheless, as shown in FIG. 2. In a shop the buyer selects the goods they wish to purchase and carries them to the check-out, often in a shopping basket. The details of the goods are entered into a computer system, the shop's till 201, either by being keyed in or by scanning barcodes on the goods. Next payment for the total amount due is taken. This may be by the buyer handing over cash, but also payment by debit or credit card is frequently used. The details of the buyer stored in their debit or credit card are transferred to the sellers till by reading it with a card payment reader 202 connected to the till. The till then contacts the computer system 203 of the payment service via the Internet, or a private network, and sends a message to the payment service computer giving the buyer's details from the credit or debit card and indicating the total amount for which payment is requested.

In this system of immediate goods delivery and computers 201, 203 making the payment transfer, there is also trust between the buyer and the seller. Both can see the goods in front of them and both have long experience of the till computer 201 and bank computers 203 interacting reliably over the network to effect the payment.

However, present systems of computers connected by the Internet or other networks do not facilitate the delivery of goods and transfer of payment in other cases.

For example, some websites allow sellers to advertise their goods and services but then take no part in the transaction, neither handling the payment transfer nor making the delivery of the goods or services. Such sites are often used by small businesses and individuals selling one-off second hand goods. Here the buyer and seller have to make the arrangements for payment and the delivery themselves.

As illustrated in FIG. 3 the seller places the advertisement on the server computer 301 of the advertising website which displays the advertisement via the device or computer 302 of a potential buyer. The buyer then contacts the seller directly, for example by sending an email to the seller's computer or device 303. Once the sale is agreed the buyer pays, for example using an online banking application in which the buyer's device or computer 302 contacts the payment service computer 304 of their bank.

However, the buyer is left with the problem that the seller may not deliver the goods and the distributed computer system of FIG. 3 does not serve to provide any trust that they will. Sending money via traditional methods, bank transfer, PayPal, Western Union etc. to people who are not highly trusted, e.g. family or friends, is very dangerous and will lead to financial losses in many cases.

In some cases an option is for them to meet with the goods. For example in the sale of a second hand car the buyer and seller will meet with the vehicle, the seller bringing the vehicle with them or the buyer travelling to the seller's home. After inspection of the vehicle and agreement of the sale, payment is needed. Carrying a large amount of cash as needed to pay for a vehicle is not wise. Other forms of payment can take some time to arrange. Even then online banking only helps a little in this situation. The buyer can use their mobile phone 302 to make the payment, but this is not always without difficulty. Many online banking systems limit the amount transferrable on one day; others have extra formality for a payment is to a payee that the bank account holder has not made payments to before. Also payments can take a while to arrive, meaning that for example the buyer has to rely on viewing on the buyer's mobile phone evidence of the payment being made, if the transaction is to be concluded swiftly with the buyer being allowed to drive the vehicle away immediately.

Another situation where parties remote from each other wish to cooperate is in the ordering of bespoke goods and services. The Internet provides sophisticated types of communication, for example transfer of text and images by email and other systems, allowing detailed specifications of the goods and services to be developed between the parties. Internet telephony and video conferencing are available to allow the parties to discuss the matter and achieve a high degree of clarity over what is required. These electronic communications are illustrated in FIG. 4 where the buyer's computer 401 and seller's computer 402 make those communications over the Internet 403.

Despite Internet communications achieving for the parties a high degree of certainty over the requirements for the goods or services, the Internet has not provided help with trust that the transaction will be completed. Trust between parties is easier to achieve if they are local to each other: the other party can be visited, local reputations are easier to establish and local institutions and laws can be relied upon. When the parties are remote those things do not help and a problem arises: the buyer does not want to pay up-front as they are unsure of delivery and the seller does not want to start work on the goods or services work without payment as they are unsure that they will receive it later.

Traditional banks do provide escrow services to individuals but the process is costly and time consuming involving much bureaucracy and personal visits to the bank and are therefore seldom used.

So, thus far, online websites, online banking, and online payment systems have not facilitated payment in situations where trust is low, despite the speed and high security it offers.

The present invention seeks to mitigate this problem by providing a new kind of computer system on the Internet connected to the parties.

### SUMMARY OF INVENTION

The present invention provides a method of transferring a payment in a distributed computer system connected by one or more communications networks, comprising:

providing a payment holding computer system arranged to perform the steps of:
receiving from a computer system of a first party a message indicating initiation of a new held payment and information enabling contact with a computer system of the second party, one of the first and second parties being a buyer and the other being a seller,
creating a held payment record recording details of the held payment,
sending a message to a computer system of the second party notifying of the new held payment,
obtaining payment from whichever of the first and second parties is the buyer, and recording the payment in relation to the held payment record, the payment holding computer system being arranged not to refund the payment to the buyer, and
receiving a message from a computer system indicating that the payment, or part thereof, should be released, and in response thereto transferring the payment, or the part thereof, recorded in relation to the held payment record, to the seller.

The computer system indicating that the payment should be released may be a computer system of the buyer.

The message indicating that the payment should be released may indicate that goods or services have been delivered.

The sending of the message to the second party may be by the held payment computer system sending a message to the telephone of the second party.

The sending of the message to the second party may be by the held payment computer system waiting until a computer of the second party has logged in to the held payment computer system, and then sending the message to the logged in computer system.

The obtaining of the payment may include the held payment computer system sending a message requesting the payment to a bank computer system or a payment intermediary computer system.

The method may comprise the step of the held payment computer system receiving a message from a computer system of the seller indicating that the payment should be released, and in response thereto transferring the payment recorded in relation to the held payment record to the buyer.

The method may comprise the step of the held payment computer system verifying the identity of the first or the second party or both. The verifying may include the held payment computer system sending a message to a person verification computer system requesting that to verify the identity of the first or the second party or both.

The method may comprise the step of the held payment computer system checking for an impediment to the one or other or both of the parties taking part in a held payment. The verifying may include the held payment computer system sending a message to a person verification computer system requesting that to check for an impediment to the one or other or both of the parties taking part in a held payment.

The present invention also provides a payment holding computer system arranged to perform the steps of the said method of the payment holding computer system as defined above.

The present invention also provides computer program product that when executed on a computer system performs the method of the payment holding computer system as defined above.

### BRIEF DESCRIPTION OF THE FIGURES

Embodiments of the invention will now be described, by way of example only, with reference to the accompanying drawings, of which

FIG. 1 shows a known distributed computer system including a website for purchasing goods and payment and fulfilment computer stems,

FIG. 2 shows a known distributed computer systems used to effect payment in a traditional shop,

FIG. 3 shows a known distributed computer system including a website for advertising goods and an online payment system,

FIG. 4 shows a known distributed computer system including those of remote parties where bespoke goods or services are required by one of the parties,

FIG. 5 shows a distributed computer system according to an embodiment of the invention,

FIGS. 6a and 6b show a flowchart of the steps taken in the embodiment of FIG. 5, and

FIG. 7 is a flowchart of a person verification and account creation process.

FIG. 8 depicts a computing machine and a system applications module in accordance with example embodiments.

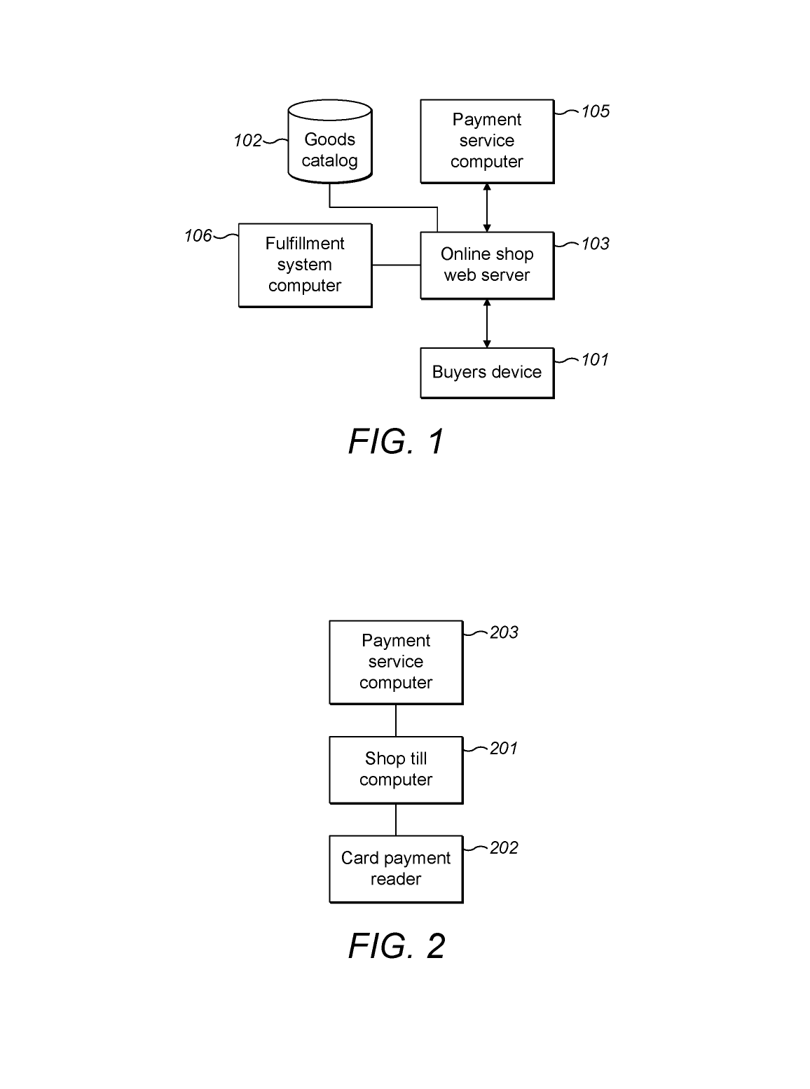

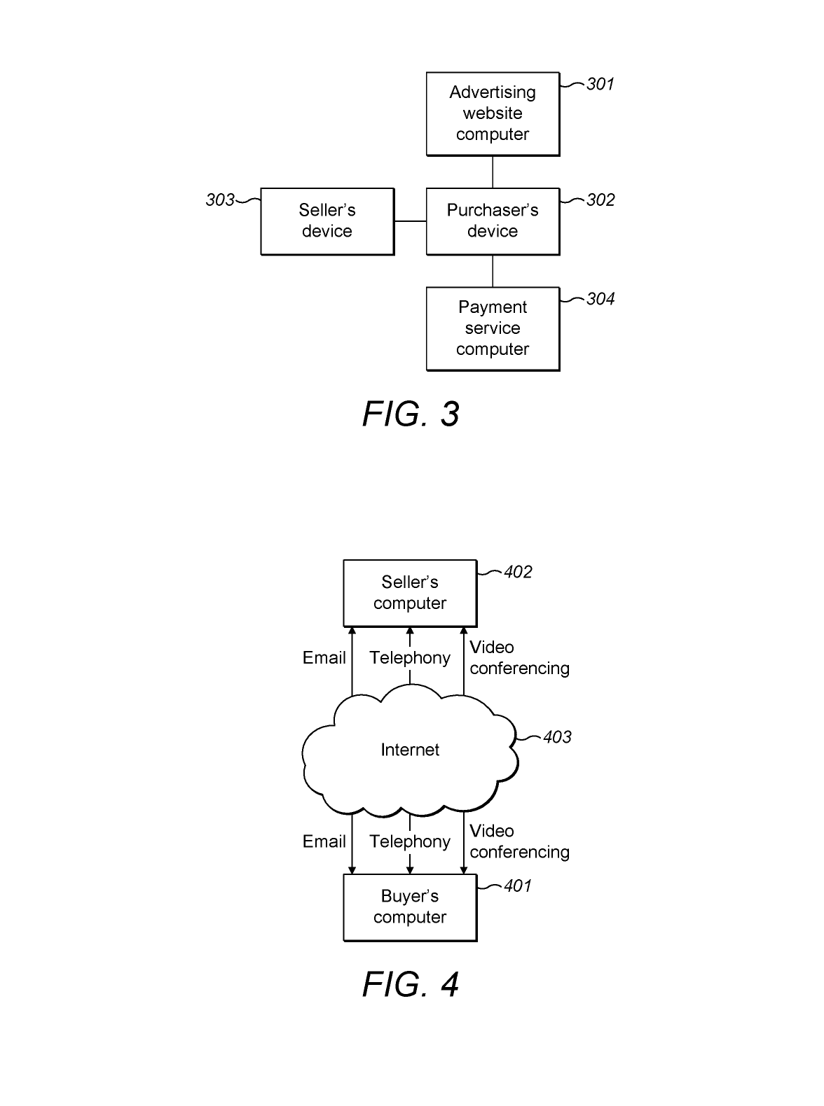

### EMBODIMENTS

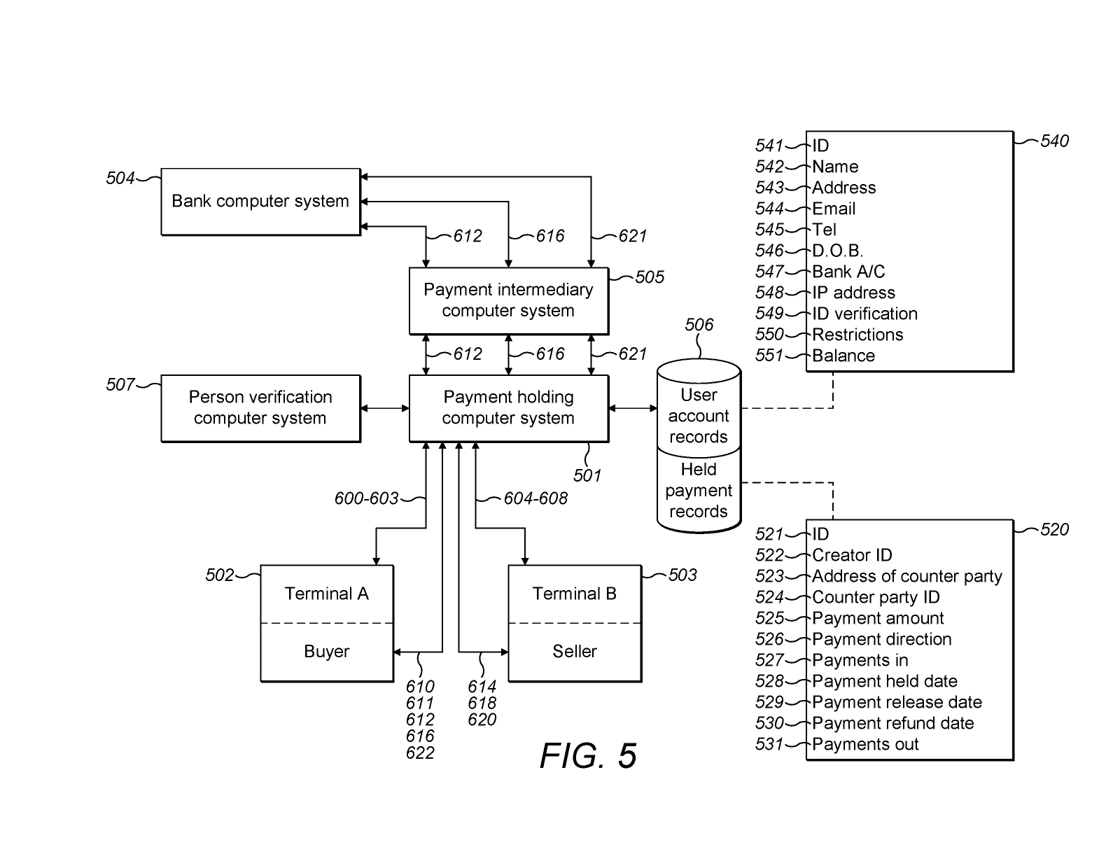

FIG. 5 is a block diagram showing a distributed computer system according to a first embodiment the invention. At its heart is a payment holding computer system 501. Parties A and B each have respective computer systems 502 and 503 with which they communicate with the payment holding computer system 501 over the Internet and/or some other communications network. In this embodiment computer systems 502 and 503 act as client computers or computer terminals to allow parties A and B communicate with the payment holding computer system 501, and hence they are marked “Terminal A” and “Terminal B” respectively. Those computers 502 and 503 in general, of course, can be any kind of computer but typically are, for example, ordinary personal computers, mobile telephones, for example smart phones, tablets and so on.

The payment holding computer system 501 also communicates with bank computer systems 504. These may be that of a single bank but alternatively the payment holding computing system 501 communicates with a plurality of bank computer systems 504 as necessary. In order to simplify communication with bank computer systems 504, in some embodiments the payment holding computer system 501 communicates with those via a payment intermediary computer system 505. (Payment intermediary computer systems 505 are known in the art of online shop websites and were provided to simplify the interface with bank computer systems, and so payment intermediary systems are already available for use by the payment holding computer system 501 of the present invention.)

The payment holding computer system 501 also communicates with a person verification computer system 507. This undertakes the task of checking whether the parties should be allowed to take part in a transaction, for example including verifying their identity and or verifying whether they are prohibited for anti-money laundering reasons.

Communication between the payment holding computer system 501 and the bank computer system 504, via the payment intermediary computer system 505 if that is being used, and with the person verification computer system 507, is via the Internet and/or other communications network.

Payment holding computer system 401 has a database 506 in which it stores various records used in its process. Of those are shown exemplary field structures of a held payment record 520 and a user account record 540.

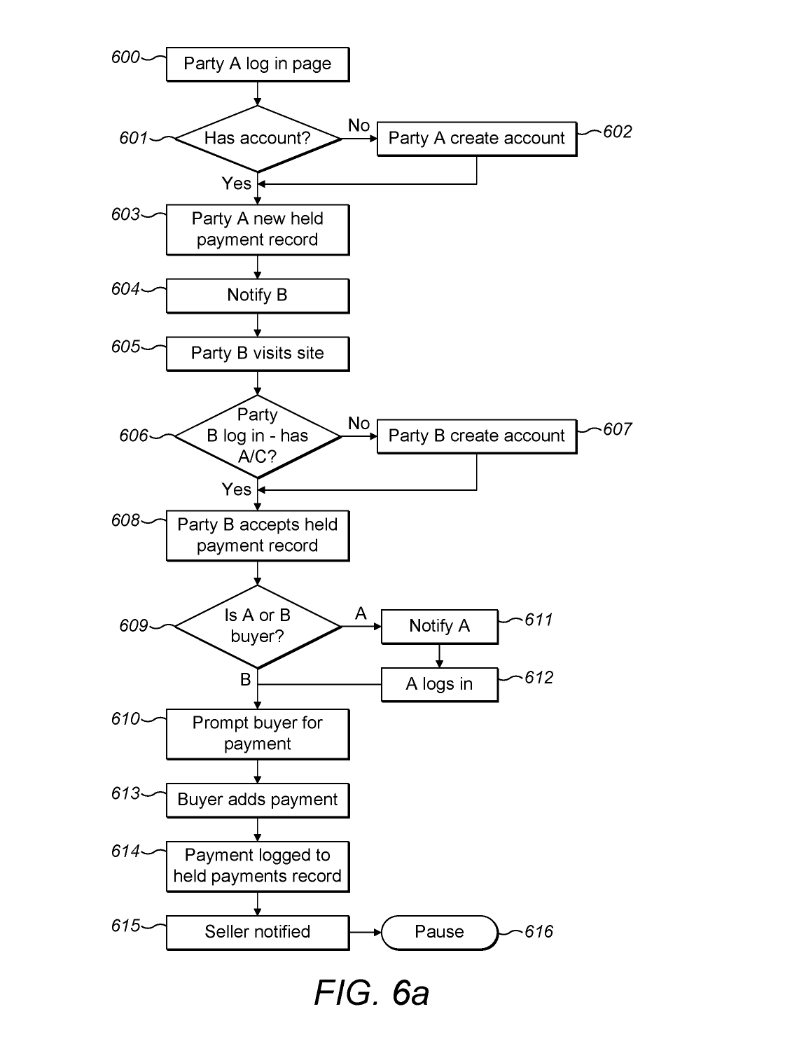

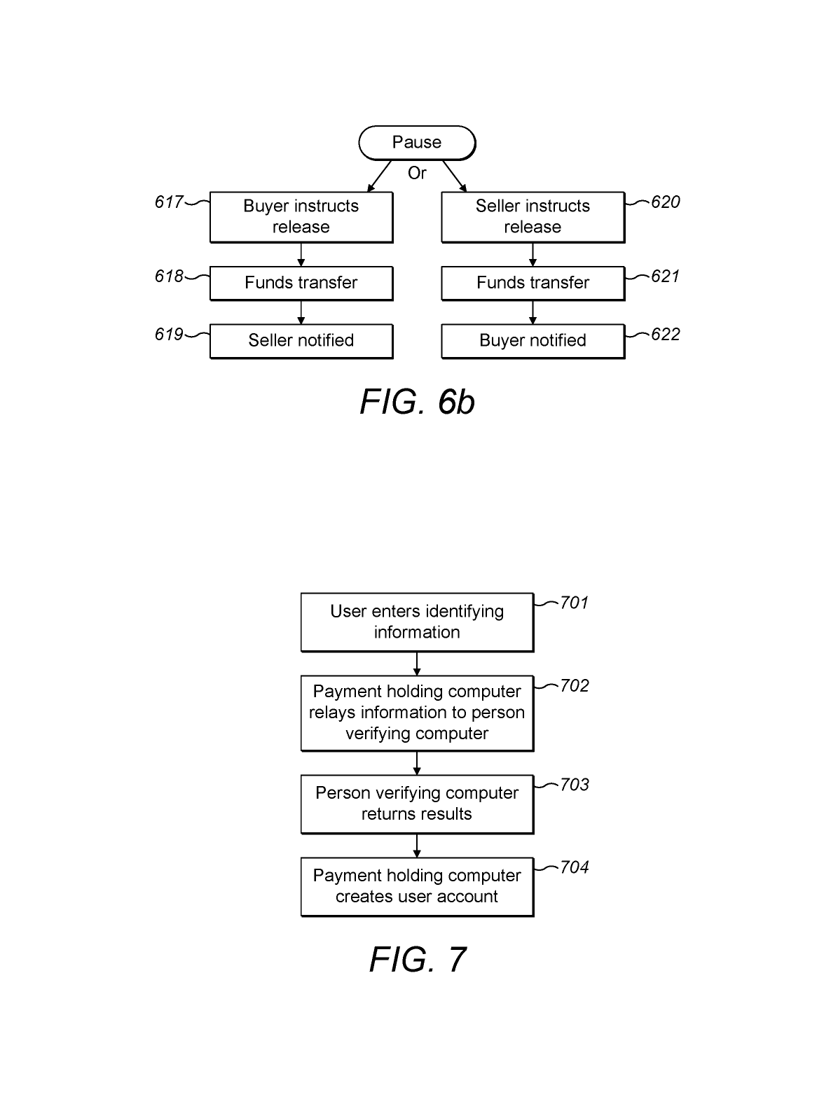

FIGS. 6a and 6b are a flow chart showing the steps taken by the computer systems of FIG. 5, and the signals or messages sent between them, in this embodiment of the invention. FIG. 6b follows on from FIG. 6a. In this method either party A and B can each be the buyer and the other the seller. For ease of illustration, in FIG. 5 party A is identified as the buyer and party B as the seller, by marking “Buyer” on the computer system 502 of party A and computer system and “Seller” on the computer system 503 of party B. However, those signals or messages that relate to party A being the buyer are marked with arrows that end on the box 502 near the word “Buyer” and similarly those that relate to party B being the seller are marked with arrows that end on the box 502 near the word “Seller”. Therefore if party A and party B have the opposite roles in the method, which is equally possible in this embodiment, that would be illustrated by in FIG. 5 by swapping over the words “Buyer” and “Seller” and moving their related arrow ends with them.

The method of this embodiment begins with one party, who is labelled here as party A, visiting 600 a log in page of a website hosted by the payment holding computer system 501. The payment holding computer system determines 601 that party A has an account on that system by party A successfully logging in. If party A does not have an account they navigate 602 to an account creation page where party A enters sufficient details and the payment holding computer system 501 then creates 602 an account for party A and logs them in. Payment holding computer system 501 stores the details of A's account in its database 506.

FIG. 7 shows that process in more detail. In a first step 701 the server provides an input form to the party's computer 502/503 asking for the party to enter various information identifying themselves, including, for example, their name, address, telephone number, email address, date of birth, national registration number such as a social security number, bank account details and so on, and the party enters at least some of those. In the next step 702 the payment holding computer system sends those details to the person verification computer system 507 and that system then verifies from that the information given is sufficient and consistent enough to identify an individual and also check for some possible impediments to a user being allowed to take part in a transaction, for example, bankruptcy, outstanding court judgements requiring payment or other credit risks, money laundering risks, politically exposed persons and sanctions checks and a check that the party is still alive. In the next step 703 the person verification computer system 507 sends its results as to whether the party's identity is verified back to the payment holding computer system 501, along with values it has found for at least some of any identity items missing from the parties input. Then, in step 704, the payment holding computer system creates a user account record 540 in its database 506. FIG. 5 shows the field structure of an exemplary user account record. This includes the following fields (which are abbreviated in FIG. 5):
541 Internal databases index number (record ID)
542 name
543 address
544 email address
545 telephone number
546 date of birth
547 bank account details—for payments to the party
548 IP address of the party's computer used to create the account
549 results of identity verification
550 results of transaction restriction indications from the person verification computer system
551 available balance of the party's account with the payment holding computer system. The initial balance is in this embodiment and will usually be zero.

The party is asked to provide their bank account details because for both buyers and the sellers there are situations in which they are to be paid out by the payment holding computer system.

Some of the fields above may comprise more than one atomic database field, or indeed at set of records in a separate database table linked to this main part of the record, as will be appreciated by those skilled in the art of databases.

The checks made by the person verification computer 501 will differ from country to country, not only because different checks may be available, but also due to different laws about which checks are prohibited or indeed are mandatory.

Such computer systems already exist on the internet and are therefore available to the system of the present invention. However in other embodiments the payment holding computer system 501 includes its own server or software module itself.

Once they are logged in a user is presented, by the payment holding computer system 501, with a menu allowing them to undertake various actions. However, next or at some point, in this embodiment party A navigates 603 to a page, provided by the payment holding computer system 501, for creating a new held payment record 520. Party A does this by providing information allowing electronic communication with party B, who is their intended counter party for the payment, which is done by party A entering the information into their computer system 502, which then communicates that to the payment holding computer system 501. In this embodiment this information is an address for communication with party A, for example, a telephone number or an email address, but in other embodiments may be information identifying party B that allows the payment holding computer system to look up such an address, for example in its own account records 540, if the information provided is an identifier in those records, for example an account name or number. In this embodiment it is not necessary, however, for party B to have an account with payment holding computer system. Party A may also provide in this step the intended amount of the payment and an indication of which way the payment is to be transferred between the parties, i.e. an indication of whether party A is the buyer or the seller. The payment holder computer system 501 creates a new held payment record having in it initially an indication of the parties, in this case of parties A and B, or, in the case of party B, possibly just their contact details. Computer system 501 further stores in that record the intended amount of the payment and the indication of which way the payment is to be transferred between the parties, if they were provided by party A.

The new payment records includes the following fields (which are abbreviated in FIG. 5), including several which are blank initially:
521 internal databases index number (record ID)
522 record ID of party creating the payment record (party A)
523 communication address for the payment counter party (party B)
524 record ID of counter party, party B
525 intended payment amount
526 payment direction, A to B or B to A
527 payments made in
528 payment held date and time
529 date and time payment released
530 date and time refund released
531 payments made out

Some of the fields above may comprise more than one atomic database field, or indeed a set of records in a separate database table (particularly here for example the payments in and out values) linked to this main part of the record, as will be appreciated by those skilled in the art of databases.

Next in this embodiment, payment holding computer system 501 notifies 604 party B that party A, or that at least someone, would like to be involved in a payment with them, by sending an electronic message, preferable immediately, for example an SMS text message to party B's cell phone, or by email, and so on. In some embodiments the notification message is delayed, for example, to a time of day preferred by party B, or by being displayed to party B on a web page when party B next logs into the website of the payment holding computer system 501. In this embodiment the message provides party B with a link to the website including information that identifies to the payment holding computer system the new held payment record concerned. This allows not only party B to navigate easily to the website of the payment holding computer system 501 if they do not have an account with it and are unfamiliar with it, but if party B does not have an account using the link allows the payment holding computer system to identify which new payment record 520 party B wishes to take part in.

Party B responds, immediately or at a time of their convenience, to that notification 604, by using their computer system 503, to visit 605 the website of the payment holding computer system 501.

The payment holding computer system 501 responds by navigating 606 party B to a log in web page and determines that party B has an account on that system by party B successfully logging in. If party B does not have an account they navigate 607 to an account creation page 603 where party B enters sufficient details and the payment holding computer then creates 607 an account for party B and logs them in. This process proceeds in the same way as for the other party as described above with reference to FIG. 7.

Once they are logged in, party B is presented with a menu allowing them to undertake various actions. However, next or at some point, in this embodiment party B navigates 608 to a page for accepting, or modifying, the new held payment 520 that was initiated by party A. Described first here is the case where party A provided the intended amount of the payment and the indication of which of party A and party B is the seller and which is the buyer and where party B wishes to accept the payment with those values. If that is not the case, or party B wishes to modify either the amount, or even to modify who is the buyer and who is the seller, then the method followed in this embodiment is also described a little later below.

Next party B uses their computer system 502 to communicate 608 to the payment holding computer 501 that they accept the payment with the amount specified by party A and that they accept the indication of who is the buyer and who is the seller, as recorded in the held payment record 520. The payment holding computer system responds to that communication by first checking 609 which of the parties is the buyer. If party B is the buyer, they are logged in already and so the payment holding computer system 501 then sends a web page to the computer system 502 of party B for display, prompting 610 them for payment of the intended amount.

If party A is the buyer, the payment holding computer system 501 sends a message 611 to party A notifying them that seller has accepted the payment as described in the held payment record and that party A should therefore make a payment, by sending an electronic message, preferable immediately, for example an SMS text message to party A's cell phone, or by email, and so on. In some embodiments the notification message is delayed, for example, to a time of day preferred by party A, or by being displayed to party A on a web page when party A next logs in 612 to the website of the payment holding computer system 501. Party A, either in response to that message (either immediately, or at their earliest convenience) or simply just to check, logs on the website of the payment holding computer system 501. The payment holding computer system 501 then sends a web page to the computer system 501 of party A for display, prompting 610 them for payment of the intended amount.

In the case that party B wishes to modify the amount proposed by party A or has been left by party A to propose the amount of the payment, or even if party B wishes to modify who is the buyer and who is the seller, party B enters the new details. The payment holding computer system responds by sending a message to party A notifying them of the changes and party A responds using their computer system 502 to communicate to the payment holding computer system 501 that they accept the payment with the amount specified by party B and that they accept the indication of who is the buyer and who is the seller, as recorded in the held payment record 520. The payment holding computer system 501 then messages party A asking them to accept the new details, which they can then do in the manner described above. The process of modifying the details of the payment can continue back and forth until one side accepts the other's proposal.

In both cases the method proceeds as follows.

The buyer, whether party B or party A, then makes a payment 613 to the payment holding computer system 501. The computer payment holding system 501 sends 613 web pages to the buyer's computer system to collect information to do that. These web pages collect the details necessary to obtain payment from the buyer's bank, credit card account, etc. The payment holding computer system 501 contacts the relevant payment service 504/505, which, once the authenticity of the payment instruction is verified, transfers the payment, in this embodiment, to a bank account of the payment holding computer system 501. Preferably this bank account is a “client money”, safeguarded or “for the benefit of” bank account and so understood legally to belong to the respective users of the payment holding computer system 501, i.e. the buyers, rather than to the payment holding computer system 501 itself (i.e. actually rather than to belong to its operators or other person responsible for it).

Note that in the system provided by invention the buyer does not have to make payment to the seller—it is made to the payment holding computer system 501; in fact the buyer does not have to know the bank details of the seller. This arrangement provided by the system of the invention is therefore much more secure than peer-to peer payments and should give buyers much more confidence.

The payment holding computer system 501 then updates 614 its held payment record 520 in its database 506 with the amount paid (in field 527) and in some embodiments adding also details such as the name of the person who paid the money and the time of the payment made. It also marks the current time and date in field 528 of the record 520 signifying that the payment holding computer system is now holing the payment on behalf of the parties. Then the payment holding computer system 501 notifies 615 the seller that the payment has been made, by sending an electronic message, preferable immediately, for example an SMS text message to sellers cell phone, or by email, and so on. In some embodiments the notification message is delayed, for example, to a time of day preferred by the seller, or by being displayed 615 to the seller on a web page when the seller next logs in to the website of the payment holding computer system 501.

At this point, the method of the distributed computer system of FIG. 5 is usually 616 paused for a significant time, while for example the seller prepares bespoke goods or services that are the subject of the payment.

The flow chart of the method continues at box 616 of FIG. 6b.

Once some suitable stage has reached, for example, the goods or services have been delivered, the buyer takes the next step 617 in that case, which is to send an instruction to the payment holding computer system 501 to release the held payment to the seller. This is done by the buyer using their computer system to log in to the payment holding computer system 501 and navigating to a web page for the purpose, which the payment holding computer system 501 provides to their computer system for display. The buyer clicks a button in the web page for the purpose and then the buyer's computer system signals 617 the release of the payment to the payment holding computer system 501. The payment holding computer system 501 responds by releasing the funds by making 618 a transfer of the funds noted in the held payment record to the seller. This may be done in at least two different ways. In a first possible way the payment holding computer system 501 sends a message to the bank computer system 504, which may be via the payment intermediary computer system 505, to transfer the funds from its client money account to the bank account of the seller. In a second possibility the payment holding computer system 501 makes a note in its record 540 of the seller's account in its database 506 of a credit of that amount, adding the credit to field 551, and the seller may then, when they next log in or subsequently, order the transfer to its bank, allowing the seller to specify then the destination account and/or to aggregate payments it has received through the payment holding computer system 501, to be paid out together in a single transfer.

The computer system notes this release of funds by setting field 529 of the held payment record 520 to the current time and date. The seller is also notified 619 that the funds have been released to them, by sending an electronic message, preferable immediately, for example an SMS text message to the seller's cell phone, or by email, and so on. In some embodiments the notification message is delayed, for example, to a time of day preferred by the seller, or by being displayed to the seller on a web page when the seller next logs in to the website of the payment holding computer system 501.

If things have not gone according to plan between the buyer and the seller, the buyer may choose not to release the payment. However, in this embodiment payment holding computer system 501 does not allow the buyer to simply take the payment back (the held payment record 520 being marked as a held payment by the entry in field 528). In many cases nonetheless the seller will recognise that a refund is due and they will make a refund.

In this case the seller takes the next step 620 after the pause which is to send an instruction to the payment holding computer system 501 to refund the held payment to the buyer. This is done by the seller using their computer system to log in to the payment holding computer system 501 and navigating to a web page for the purpose, which the payment holding computer system 501 provides to their computer system for display. The seller clicks a button in the web page for the purpose and then the seller's computer system signals the refund of the payment to the payment holding computer system 501. The payment holding computer system 501 responds by marking the fact of the refund with an entry of the current time and date in field 530 of the held payment record 520 and by refunding the funds by making 621 a transfer to the buyer of the funds noted in the held payment record. This may be done in at least two different ways. In a first possible way the payment holding computer system 501 sends a message to the bank computer, which may be via the payment intermediary computer system 505, to transfer the funds from its client money account to the bank account of the buyer. In a second possibility the payment holding computer system 501 makes a note in its record 540 of the buyer's account on its system of a credit of that amount, adding the credit to field 551, and the buyer may then, when they next log in or subsequently, order the transfer to its bank, allowing the buyer to specify the destination account at that time.

The buyer is also notified 622 that the funds have been released to them, by sending an electronic message, preferable immediately, for example an SMS text message to the seller's cell phone, or by email, and so on. In some embodiments the notification message is delayed, for example, to a time of day preferred by the buyer, or by being displayed to the buyer on a web page when the buyer next logs in to the website of the payment holding computer system 501.

If, in some cases, neither the buyer instructs the payment holding computer system 501 to release the payment nor the seller instructs the payment holding computer system 501 to refund the funds, then an impasse is reached with the payment holding computer system 501 continuing to hold the money (as signified by field 528 being completed but field 530 not), which dispute will have to be resolved through some dispute resolution procedure. Nonetheless the payment holding computer system 501 of invention still, through the method it executes and the messages it sends, provides confidence to the parties that the money is there and that work can go ahead or the item can be sent once the buyer has made their payment. If the buyer will not release the payment it knows that it cannot regain the money by disappearing or simply by withholding payment—the money is held by the payment holding computer system 501. The buyer must be prepared to resolve any dispute or if it does disappear it is likely that a court will order a release of the funds to the seller.

As such, the present disclosure reduces the amount of data storage and messaging associated with such transactions, because otherwise, the involved parties must involve the associated financial institutions in any messages related to the transactions, which not only requires additional communications resources, but which also increases the amount of storage space required for storing such messages at the computing equipment of all involved parties. By eliminating the need for messages involving each of the associated financial institutions of the buyer and the seller while the parties determine whether the transaction has been concluded in accordance with the terms of agreement between the parties, the present disclosure eliminates the need for the financial institutions to be involved in such transactions to the extent of needing to know such terms, and this also increases the amount of privacy for buyers and sellers. Therefore, the present disclosure provides a number of advantages over prior art systems that require each of the financial institutions of the buyer and the seller to be involved with the determination of whether a transaction has been completed in accordance with its terms, and allows the parties to the transaction to be solely responsible for the decision of whether to release payment once the transaction has been completed or to terminate the transaction and to reverse payment. (It is noted that a financial institution of a party can host the transaction server or other associated systems that are required or otherwise used, if that situation is acceptable to both parties).

The held payment computer system described above is typically a server computer or a plurality of cooperating computer systems. For example that may comprise a database server used to hold and update the database 506 and an application server that interfaces with the parties, for example by running a web server, and executes the logic of the system as described above. The computers of the system may comprise standard general purpose computers provided with a suitable computer program.

The parties' computers 502 and 503 may be ordinary personal computers but may also be smart phones, or tablets or the like. The parties are not limited to using one particular computer for their interactions with the payment holding computer system but may use different ones at different stages.

Interaction of the computers of the parties with the payment computer system in the main embodiment is unless described otherwise, by the sending or web pages and the responses thereto. Other forms of interaction may be used, for example, providing the parties computers with a bespoke client program such as an web-based or mobile application, the payment holding server having a corresponding bespoke interface for that to communicate with.

The computer payment holding system has also been described as interacting directly with the computers used directly by the parties but may also be an intermediary computer acting on their behalf, for example a website computer facilitating trade in a certain area of commerce, or a computer system of a bank through whom the party is making the payment. In that sense the intermediary computer is a computer of the relevant party when it carries out the actions described herein on behalf of the party. In this case the payment holding system is programmed to provide an API to the payment holding computer system accessible over the communications network between them.

Above it has been described that the buyer releases the amount paid in to the seller. However in some embodiments the buyer may indicate that a part of the sum paid may be released to the seller and the system is arranged accordingly to release to the seller only that part.

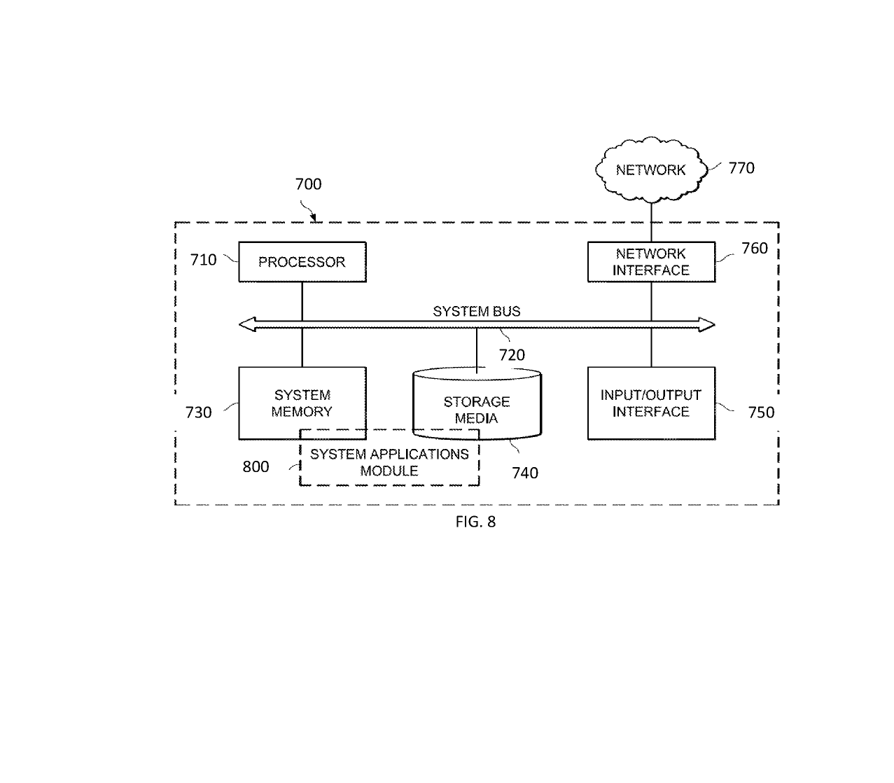

FIG. 8 is a computing machine 700 and a system applications module 800 in accordance with example embodiments. The computing machine 700 can correspond to any of the various computers, mobile devices, laptop computers, servers, embedded systems, or computing systems presented herein. The module 800 can comprise one or more hardware or software elements designed to facilitate the computing machine 700 in performing the various methods and processing functions presented herein. The computing machine 700 can include various internal or attached components such as a processor 710, system bus 720, system memory 730, storage media 740, input/output interface 750, and a network interface 760 for communicating with a network 770.

The computing machine 700 can be implemented as a conventional computer system, an embedded controller, a laptop, a server, a mobile device, a smartphone, a wearable computer, a customized machine, any other hardware platform, or any combination or multiplicity thereof. The computing machine 700 can be a distributed system configured to function using multiple computing machines interconnected via a data network or bus system.

The processor 710 can be designed to execute code instructions in order to perform the operations and functionality described herein, manage request flows and address mappings, and to perform calculations and generate commands. The processor 710 can be configured to monitor and control the operation of the components in the computing machine 700. The processor 710 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 710 can be a single processing unit, multiple processing units, a single processing core, multiple processing cores, special purpose processing cores, co-processors, or any combination thereof. According to certain embodiments, the processor 710 along with other components of the computing machine 700 can be a virtualized computing machine executing within one or more other computing machines.

The system memory 720 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 720 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 720. The system memory 730 can be implemented using a single memory module or multiple memory modules. While the system memory 730 is depicted as being part of the computing machine 700, one skilled in the art will recognize that the system memory 730 can be separate from the computing machine 700 without departing from the scope of the subject technology. It should also be appreciated that the system memory 430 can include, or operate in conjunction with, a non-volatile storage device such as the storage media 740.

The storage media 740 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 740 can store one or more operating systems, application programs and program modules, data, or any other information. The storage media 740 can be part of, or connected to, the computing machine 700. The storage media 740 can also be part of one or more other computing machines that are in communication with the computing machine 700 such as servers, database servers, cloud storage, network attached storage, and so forth.

The system applications module 800 can comprise one or more hardware or software elements configured to facilitate the computing machine 700 with performing the various methods and processing functions presented herein. The module 800 can include one or more sequences of instructions stored as software or firmware in association with the system memory 730, the storage media 740, or both. The storage media 740 can therefore represent examples of machine or computer readable media on which instructions or code can be stored for execution by the processor 710. Machine or computer readable media can generally refer to any medium or media used to provide instructions to the processor 710. Such machine or computer readable media associated with the module 800 can comprise a computer software product. It should be appreciated that a computer software product comprising the module 800 can also be associated with one or more processes or methods for delivering the module 800 to the computing machine 700 via the network 770, any signal-bearing medium, or any other communication or delivery technology. The module 800 can also comprise hardware circuits or information for configuring hardware circuits such as microcode or configuration information for an FPGA or other PLD. In one exemplary embodiment, module 800 can include algorithms capable of performing the functional operations described by the flow charts and computer systems presented herein for performing an on-line payment.

The input/output (“I/O”) interface 750 can be configured to couple to one or more external devices, to receive data from the one or more external devices, and to send data to the one or more external devices. Such external devices along with the various internal devices can also be known as peripheral devices. The I/O interface 750 can include both electrical and physical connections for coupling the various peripheral devices to the computing machine 700 or the processor 710. The I/O interface 750 can be configured to communicate data, addresses, and control signals between the peripheral devices, the computing machine 700, or the processor 710. The I/O interface 750 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 750 can be configured to implement only one interface or bus technology. Alternatively, the I/O interface 750 can be configured to implement multiple interfaces or bus technologies. The I/O interface 750 can be configured as part of, all of, or to operate in conjunction with, the system bus 420. The I/O interface 750 can include one or more buffers for buffering transmissions between one or more external devices, internal devices, the computing machine 700, or the processor 710.

The I/O interface 750 can couple the computing machine 700 to various input devices including mice, touch-screens, scanners, electronic digitizers, sensors, receivers, touchpads, trackballs, cameras, microphones, keyboards, any other pointing devices, or any combinations thereof. The I/O interface 750 can couple the computing machine 700 to various output devices including video displays, speakers, printers, projectors, tactile feedback devices, automation control, robotic components, actuators, motors, fans, solenoids, valves, pumps, transmitters, signal emitters, lights, and so forth.

The computing machine 700 can operate in a networked environment using logical connections through the network interface 760 to one or more other systems or computing machines across the network 770. The network 770 can include wide area networks (WAN), local area networks (LAN), intranets, the Internet, wireless access networks, wired networks, mobile networks, telephone networks, optical networks, or combinations thereof. The network 770 can be packet switched, circuit switched, of any topology, and can use any communication protocol. Communication links within the network 770 can involve various digital or an analog communication media such as fiber optic cables, free-space optics, waveguides, electrical conductors, wireless links, antennas, radio-frequency communications, and so forth.

The processor 710 can be connected to the other elements of the computing machine 700 or the various peripherals discussed herein through the system bus 720. It should be appreciated that the system bus 720 can be within the processor 710, outside the processor 710, or both. According to some embodiments, any of the processor 710, the other elements of the computing machine 700, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A method of transferring a payment in a distributed computer system connected by one or more communications networks, comprising:
providing a payment holding computer system arranged to perform the steps of:
receiving from a computer system of a first party a message indicating initiation of a new held payment and information enabling contact with a computer system of the second party, one of the first and second parties being a buyer and the other being a seller,
creating a held payment record recording details of the held payment,
sending a message to a computer system of the second party notifying of the new held payment,
obtaining payment from whichever of the first and second parties is the buyer, and recording the payment in relation to the held payment record, the payment holding computer system being arranged not to refund the payment to the buyer, and
receiving a message from a computer system indicating that the payment, or part thereof, should be released, and in response thereto transferring the payment, or the part thereof, recorded in relation to the held payment record, to the seller.

2. A method according to claim 1 wherein the computer system indicating that the payment should be released is a computer system of the buyer.

3. A method according to claim 1 wherein the message indicating that the payment should be released indicates that goods or services have been delivered.

4. A method according to claim 1 wherein the computer system indicating that the payment should be released is a computer system of the buyer, and the message indicating that the payment should be released indicates that goods or services have been delivered.

5. A method according to claim 1 wherein the sending of the message to the second party is by the held payment computer system sending a message to the telephone of the second party.

6. A method according to claim 1 wherein the sending of the message to the second party is by the held payment computer system waiting until a computer of the second party has logged in to the held payment computer system, and then sending the message to the logged in computer system.

7. A method according to claim 1 wherein the obtaining of the payment includes the held payment computer system sending a message requesting the payment to a bank computer system or a payment intermediary computer system.

8. A method according to claim 1 comprising the step of the held payment computer system receiving a message from a computer system of the seller indicating that the payment should be released, and in response thereto transferring the payment recorded in relation to the held payment record to the buyer.

9. A method according to claim 1 comprising the step of the held payment computer system verifying the identity of the first or the second party or both.

10. A method according to claim 9 wherein the verifying includes the held payment computer system sending a message to a person verification computer system requesting that to verify the identity of the first or the second party or both.

11. A method according to claim 1 comprising the step of the held payment computer system checking for an impediment to the one or other or both of the parties taking part in a held payment.

12. A method according to claim 10 wherein the verifying includes the held payment computer system sending a message to a person verification computer system requesting that to check for an impediment to the one or other or both of the parties taking part in a held payment.

13. A payment holding computer system arranged to perform the steps of the method of the payment holding computer system as defined in claim 1.

14. A computer program product that when executed on a computer system performs the method of the payment holding computer system as defined in claim 1.

15. A system for transferring a payment in a distributed computer system connected by one or more communications networks, comprising:
a computer-usable non-transitory storage resource; and
a processor communicatively coupled to the storage resource, wherein the processor executes application code instructions stored in the storage resource that are configured to cause the system to:
receive from a computer system of a first party a message indicating initiation of a new held payment and information enabling contact with a computer system of the second party, one of the first and second parties being a buyer and the other being a seller,
create a held payment record recording details of the held payment,
send a message to a computer system of the second party notifying of the new held payment,
obtain payment from whichever of the first and second parties is the buyer, and recording the payment in relation to the held payment record, the system being arranged not to refund the payment to the buyer, and
receive a message from a computer system indicating that the payment, or part thereof, should be released, and in response thereto transferring the payment, or the part thereof, recorded in relation to the held payment record, to the seller.

16. A system according to claim 15 wherein the computer system indicating that the payment should be released is a computer system of the buyer.

17. A system according to claim 15 wherein the message indicating that the payment should be released indicates that goods or services have been delivered.

18. A system according to claim 15 wherein the computer system indicating that the payment should be released is a computer system of the buyer, and the message indicating that the payment should be released indicates that goods or services have been delivered.

19. A system according to claim 15 wherein the sending of the message to the second party is by sending a message to a telephone of the second party.

20. A system according to claim 15 wherein the sending of the message to the second party is performed when a computer of the second party has logged in to the held payment computer system, and then sending the message to the logged in computer system.
